(19) United States
(12) Patent Application Publication
(10) Pub. No.: US 2024/0389099 A1
(43) Pub. Date: Nov. 21, 2024

(54) Method And Apparatus For Handling Simultaneous Reception In Mobile Communications

(71) Applicant: MediaTek Inc., Hsinchu City (TW)

(72) Inventor: Chiou-Wei Tsai, Hsinchu City (TW)

(21) Appl. No.: 18/610,196

(22) Filed: Mar. 19, 2024

Related U.S. Application Data
(60) Provisional application No. 63/466,376, filed on May 15, 2023.

(51) Int. Cl. H04W 72/1273; H04L 1/00; H04W 72/51; H04W 74/0833

(52) U.S. Cl. CPC H04W 72/1273; H04L 1/0003; H04W 72/51; H04W 74/0833

(57) ABSTRACT

Examples pertaining to handle of simultaneous reception in mobile communications are described. A user equipment (UE) performs a procedure to communicate with a network apparatus. The procedure involves reception of a first physical downlink shared channel (PDSCH) scheduled in a first slot. Then, the UE determines to skip decoding of a second PDSCH scheduled in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

### CROSS REFERENCE TO RELATED PATENT APPLICATION(S)

The present disclosure is part of a non-provisional application claiming the priority benefit of U.S. Patent Application No. 63/466,376, filed 15 May 2023, the content of which herein being incorporated by reference in its entirety.

### TECHNICAL FIELD

The present disclosure is generally related to mobile communications and, more particularly, to how to handle simultaneous reception of a reduced capability user equipment with respect to a network apparatus in mobile communications.

### BACKGROUND

Unless otherwise indicated herein, approaches described in this section are not prior art to the claims listed below and are not admitted as prior art by inclusion in this section.

The demand for fifth generation (5G) devices with reduced capability for lower requirements applications is growing. A reduced capability (RedCap) user equipment (UE) with fewer RX/TX capabilities, reduced bandwidth, lower power consumption, relaxed data rates, etc. has been introduced.

For an enhanced reduced capability (eRedCap) UE, UE's processing capability is further reduced which implies that the number of resource elements (REs) or resource blocks (RBs) for the UE to perform channel estimation, demodulation, and decoding is reduced. However, UE's reception capability is not reduced as compared with the legacy UE. This leads to some scenarios where the UE may receive a physical downlink shared channel (PDSCH) that exceeds its processing capability.

In addition, in some other scenarios, the UE may be supposed to receive or may be scheduled with two or more PDSCHs. The overall bandwidth of the two or more PDSCHs may exceed the eRedCap UE's processing capability.

Accordingly, how to handle simultaneous reception for the UE with reduced processing capability becomes an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to handling simultaneous reception for a communication apparatus with a reduced processing capability (e.g., a RedCap UE or an eRedCap UE) with respect to the communication apparatus and the network apparatus (e.g., a network node or a base station (BS), such as a next generation Node B (gNB)) in mobile communications.

In one aspect, a method may involve a communication apparatus performing a procedure to communicate with a network apparatus. The procedure involves reception of a first physical downlink shared channel (PDSCH) scheduled in a first slot. The method may also involve the communication apparatus determining to skip decoding of a second PDSCH scheduled in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

In one aspect, a communication apparatus may involve a transceiver which, during operation, wirelessly communicates with at least one network apparatus. The communication apparatus may also involve a processor communicatively coupled to the transceiver such that, during operation, the processor performs following operations: performing, via the transceiver, a procedure to communicate with the network apparatus, wherein the procedure involves reception of a first physical downlink shared channel (PDSCH) scheduled in a first slot; and determining to skip decoding of a second PDSCH scheduled in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

In one aspect, a method may involve a network apparatus performing a procedure to communicate with a communication apparatus. The procedure involves transmission of a first physical downlink shared channel (PDSCH) scheduled in a first slot. The method may also involve the network apparatus determining not to schedule a second PDSCH in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a 4-step random access procedure in accordance with implementations of the present disclosure.

FIG. 2 is a diagram depicting an example scenario of a 2-step random access procedure in accordance with implementations of the present disclosure.

FIG. 3 is a diagram depicting an example scenario of a P-RNTI triggered SI acquisition process in accordance with implementations of the present disclosure.

FIG. 4 is a diagram depicting an example communication system having an example communication apparatus and an example network apparatus in accordance with an implementation of the present disclosure.

FIG. 5 is a diagram depicting an example process in accordance with an implementation of the present disclosure.

FIG. 6 is a diagram depicting another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling of simultaneous reception of a communication apparatus with a reduced processing capability. According to the present disclosure, a number of possible solutions may be implemented separately or jointly. That is, although these possible solutions may be described below separately, two or more of these possible solutions may be implemented in one combination or another.

For a RedCap device (e.g., a RedCap communication apparatus or a RedCap UE), the maximum device bandwidth is up to 20 megahertz (MHz) in frequency range 1 (FR1) bands and 100 MHZ in frequency range 2 (FR2) bands in 3^{rd} Generation Partnership Project (3GPP) Release 17. In 3GPP Release 18, the maximum device bandwidth of the processing capability of an eRedCap device with respect to the PDSCH and physical uplink shared channel (PUSCH) in FR1 bands is further reduced to 5 MHz. In addition, it is agreed that there is no need to relax the requirements on simultaneous reception of two broadcast PDSCH transmissions for system information block 1 (SIB1), other system information (OSI), paging, or random access response (RAR). Considering of this, more schemes should be proposed on the signal processing in the eRedCap UE with respect to a random access (RA) procedure and a system information acquisition procedure.

In some implementations, the communication apparatus may perform a procedure to communicate with a network apparatus, wherein the procedure may involve reception of a first PDSCH scheduled in a first slot, and the communication apparatus may determine to skip decoding of a second PDSCH scheduled in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth. To be more specific, in some implementations, the communication apparatus may directly skip the receiving of the second PDSCH scheduled in the first slot or in the second slot. In some other implementations, the communication apparatus may still receive the second PDSCH scheduled in the first slot or in the second slot, but the communication apparatus is not expected to decode the second PDSCH.

In some implementations, the bandwidth of the resource scheduled for a channel (e.g., the PDSCH) may be determined based on a number of resource block (RB) configured with a sub carrier spacing (SCS). As an example, the bandwidth may be determined based on the following equation Eq. (1)

$$N\_RB \times SumOfSubcarrier \times S C S \qquad Eq . ( 1 )$$

where the parameter N_RB is the number of configured resource blocks, the parameter NumOfSubcarrier may be set to a constant value (such as 12 when a resource block is defined as comprising 12 consecutive sub carriers in the frequency domain) and the parameter SCS is the configured sub carrier spacing.

In addition, in some implementations, the aforementioned procedure may comprise a RA procedure or a paging radio network temporary identifier (RNTI) (P-RNTI) triggered system information (SI) acquisition process (or called P-RNTI triggered SI acquisition procedure).

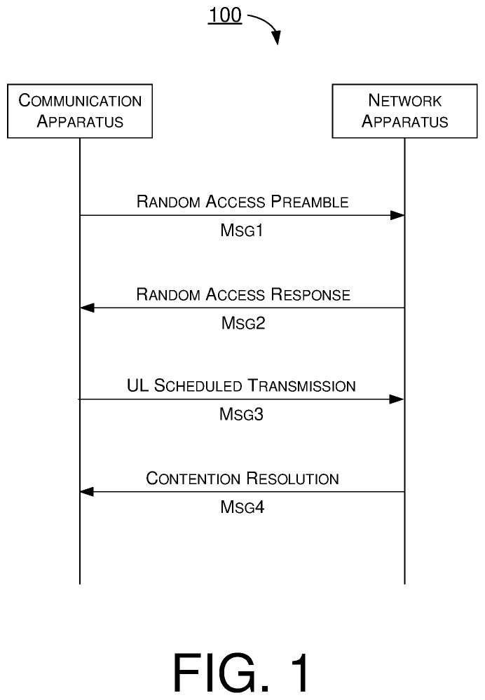

FIG. 1 illustrates an example scenario 100 of a 4-step RA procedure in accordance with implementations of the present disclosure. The communication apparatus (e.g., a UE) may select a RA preamble from a set of predefined preambles. The communication apparatus may also select a random sequence number for the preamble. After choosing the preamble and sequence number, the communication apparatus may transmit the preamble on the physical random access channel (PRACH) (i.e., transmit the message 1 (Msg 1)).

Upon receiving Msg1, the network apparatus (e.g., the gNB) may send a RAR called Msg2 to the communication apparatus. The Msg2 may consist of several critical pieces of information, such as the Time Advance (TA) command for timing adjustment, the random access preamble identifier (RAPID) matching the preamble sent by the communication apparatus, and an initial uplink grant for the communication apparatus. The network apparatus may also assign a temporary identifier called random access RNTI (RA-RNTI) to the communication apparatus.

Using the initial uplink grant provided in Msg2, the communication apparatus may transmit Msg3 on the PUSCH. The Msg3 is a PUSCH which may carry a certain radio resource control (RRC) message (such as an RRC connection request message) or just be pure physical layer data.

After processing the Msg3, the network apparatus may send Msg4 to the communication apparatus. The Msg4 is a contention resolution message containing the communication apparatus's identity, confirming that the network apparatus has correctly identified the communication apparatus, and contention has been resolved. At this step, the network apparatus may provide the communication apparatus with cell RNTI (C-RNTI).

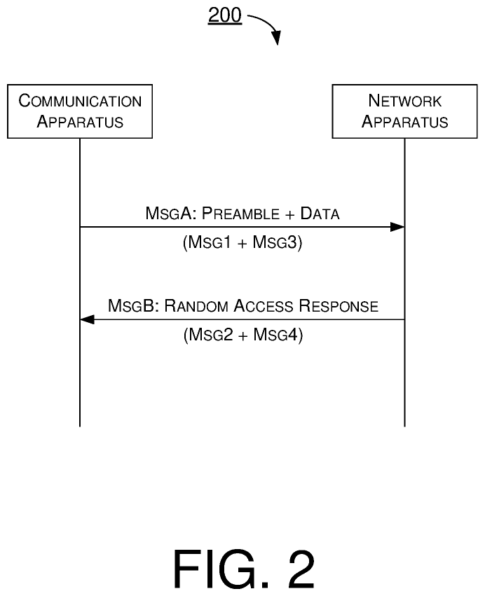

FIG. 2 illustrates an example scenario 200 of a 2-step RA procedure in accordance with implementations of the present disclosure. In the 2-step RA procedure, the MsgA may a combination of Msg1 and Msg3, and the MsgB may a combination of Msg2 and Msg4.

In some implementations, assuming that the Msg3 indication is available, for the communication apparatus with baseband (BB) complexity reduction, the communication apparatus may be able to receive a Msg4 PDSCH resource allocation spanning a bandwidth of more than 5 MHz per slot, and may be not required to process a Msg4 PDSCH with a larger number of physical RBs (PRBs) than 25 PRBs for 15 kHz SCS and 12 PRBs for 30 kHz SCS.

In addition, when the bandwidth scheduled for a PDSCH is larger than 5 MHZ, the communication apparatus may require an additional slot for processing this PDSCH as compared with the PDSCH with a scheduled bandwidth not greater than 5 MHz. Therefore, in some implementations, when the communication apparatus performs a RA procedure, which involves reception of a first PDSCH scheduled in a first slot, to communicate with a network apparatus (e.g., tries to access the network or request an uplink resource), the communication apparatus may determine to skip decoding of a second PDSCH scheduled in at least one of the first slot and a second slot following the first slot, or skip decoding of the second PDSCH scheduled in the first slot and the second slot in an event that the bandwidth scheduled for the first PDSCH is larger than a predetermined bandwidth (for example but not limited to, the bandwidth scheduled for the first PDSCH is larger than 5 MHz or the first PDSCH is allocated more than 25 PRBs when configured with SCS μ=0 or more than 12 PRBs when configured with SCS μ=1).

In some implementations, the aforementioned first PDSCH may be scheduled with an RA-RNTI of the communication apparatus or scheduled with a message B RNTI (MSGB-RNTI) of the communication apparatus.

In addition, in some implementations, the aforementioned second PDSCH may be scheduled with a C-RNTI, a modulation and coding scheme (MCS) C-RNTI (MCS-C-RNTI), a group RNTI (G-RNTI), a multicast broadcast service (MBS) control channel (MCCH) RNTI (MCCH-RNTI), a group configured scheduling RNTI (G-CS-RNTI) or a configured scheduling RNTI (CS-RNTI) of the communication apparatus.

In some implementations, in determining to skip decoding of the second PDSCH, the communication apparatus may determine to skip decoding of the second PDSCH scheduled in both the first slot and the second slot, wherein the second slot is a next slot of the first slot.

In some implementations, if a PDSCH is scheduled with RA-RNTI or MSGB-RNTI in slot n, the communication apparatus may be not expected to decode another PDSCH scheduled with C-RNTI, SI-RNTI, MCS-C-RNTI, G-RNTI for multicast or broadcast, MCCH-RNTI, G-CS-RNTI or CS-RNTI, in slots n and (n+1) if the PDSCH scheduled with RA-RANTI or MSGB-RNTI is greater than 25 PRBs with 15 kHz SCS or greater than 12 PRBs with 30 kHz SCS.

That is, in some implementations, the communication apparatus (e.g., a UE indicating supportOfERedCap-r18 capability but may not indicating eRedCapNotReducedBB-BW-r18) may be not expected to decode a PDSCH scheduled with C-RNTI, MCS-C-RNTI, G-RNTI for multicast or broadcast, MCCH-RNTI, G-CS-RNTI or CS-RNTI in the same or next slot if another PDSCH in the same cell is scheduled with RA-RNTI or MSGB-RNTI, when the PDSCH scheduled with RA-RNTI or MSGB-RNTI is allocated more than 25 PRBs when configured with SCS μ=0 or more than 12 PRBs when configured with SCS μ=1.

Regarding the SI acquisition, in RRC_Connected mode, a physical downlink control channel (PDCCH) scrambled by P-RNTI may be used to transmit “Short Messages” to notify the communication apparatus with SI modification, or public warning system (PWS) notification or commercial mobile alert system (CMAS) notification. Upon the detection of PWS and CMAS notification, a PWS/CMAS capable communication apparatus is expected to acquire the corresponding SIBs (SIB6-SIB8) immediately. For SI modification notification, the communication apparatus is expected to monitor the concerned SIBs from the start of next “SI modification period”.

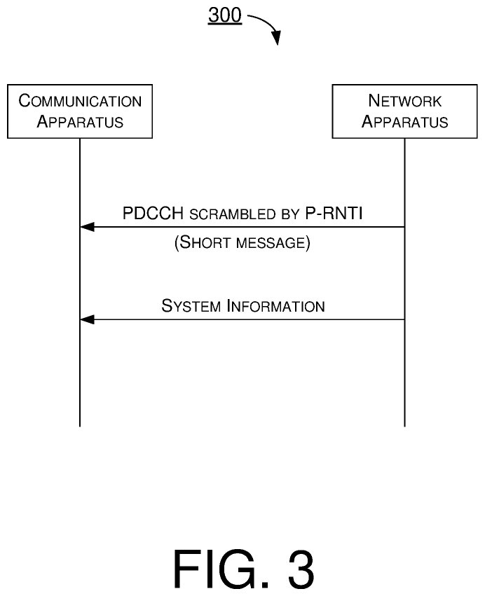

FIG. 3 illustrates an example scenario 300 of a P-RNTI triggered SI acquisition process in accordance with implementations of the present disclosure. Upon receiving the PDCCH scrambled by P-RNTI, such as a downlink control information (DCI) format 1_0 scrambled with P-RNTI, the communication apparatus is expected to acquire the corresponding system information and may start to monitor the concerned SIBs.

Therefore, the network apparatus may avoid scheduling or transmitting unicast PDSCHs (except RACH messages) in slots when the communication apparatus (e.g., the eRedCap UE) is receiving or decoding SIBs during a P-RNTI triggered SI acquisition process. Or, the communication apparatus (e.g., the eRedCap UE) may determine to skip decoding of the unicast PDSCHs in slots when receiving or decoding SIBs during a P-RNTI triggered SI acquisition process. Note that one exception may be the Msg4 scheduled with C-RNTI. When an RA procedure is triggered, the RA messages may deserve a higher priority than other PDSCHs.

In some implementations, when the communication apparatus performs a P-RNTI triggered SI acquisition procedure, which involves reception of a first PDSCH scheduled in a first slot, to communicate with a network apparatus (e.g., tries to receive system information from the network apparatus), the communication apparatus may determine to skip decoding of a second PDSCH scheduled in at least the first slot in an event that a total bandwidth scheduled for the first PDSCH and the second PDSCH is larger than the predetermined bandwidth (for example but not limited to, the total bandwidth is larger than 5 MHz or the total number of PRBs in the first slot is more than 25 PRBs when configured with SCS μ=0 or more than 12 PRBs when configured with SCS μ=1).

In some implementations, the aforementioned first PDSCH may be scheduled with an SI-RNTI.

In addition, in some implementations, the aforementioned second PDSCH may be scheduled with a C-RNTI, an MCS-C-RNTI or a CS-RNTI of the communication apparatus.

In some implementations, during a process of P-RNTI triggered SI acquisition, when a PDSCH is scheduled with SI-RNTI in slot n, the communication apparatus may be not expected to decode another PDSCH scheduled with C-RNTI, MCS-C-RNTI, or CS-RNTI in at least slot n or in slot n and slot (n+1).

In some implementations, for the communication apparatus (e.g., a UE) indicating supportOfERedCap-r18 capability but may not indicating eRedCapNotReducedBB-BW-r18, during a process of P-RNTI triggered SI acquisition, when the total number of PRBs for the PDSCH scheduled with SI-RNTI and the PDSCH scheduled with C-RNTI, MCS-C-RNTI, or CS-RNTI scheduled in the slot is larger than 25 PRBs if configured with SCS μ=0 or larger than 12 PRBs if configured with SCS μ=1, the communication apparatus may skip decoding of the scheduled PDSCH with C-RNTI, MCS-C-RNTI, or CS-RNTI.

In some implementations, during a process of P-RNTI triggered SI acquisition, when a PDSCH is scheduled with SI-RNTI in slot n, the communication apparatus may be not expected to decode another PDSCH scheduled with MCS-C-RNTI, or CS-RNTI in slot n and slot (n+1) if the PDSCH scheduled with C-RNTI is not Msg4 or a response to PRACH.

Alternatively, the PDSCH scheduled with SI-RNTI may be prioritized. The prioritization may be done in the following ways: (1) by the communication apparatus for decoding in an event that another PDSCH is scheduled overlapping the time duration when the communication apparatus is processing the PDSCH scheduled with SI-RNTI, and/or (2) by the network apparatus's implementation in an event that the network apparatus is able to refrain from transmitting another PDSCH during the communication apparatus's process of P-RNTI triggered SI acquisition.

In some implementations, during a process of P-RNTI triggered SI acquisition, the communication apparatus may be expected to decode PDSCH scheduled by C-RNTI responding to a RACH message including a Msg4 PDSCH, a network's response to Msg1-based beam failure recovery request or a MsgB PDSCH scheduled with C-RNTI.

From the aspect of the network apparatus to handle simultaneous reception of the communication apparatus, such as the eRedCap UE or the UE indicating supportOfRedCap-r18 capability, when the network apparatus performs a procedure which involves transmission of a first PDSCH scheduled in a first slot to communicate with the communication apparatus, the network apparatus may determine not to schedule a second PDSCH in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth. Note that in some implementations, the second PDSCH is a PDSCH which was supposed to be scheduled in the first slot or in the second slot.

In some implementations, the procedure may comprise a RA procedure triggered by the communication apparatus, and the first PDSCH may be scheduled with a RA-RNTI of the communication apparatus or scheduled with a MSGB-RNTI of the communication apparatus.

In addition, in some implementations, the second PDSCH may be scheduled with a C-RNTI, an MCS-C-RNTI, a G-RNTI, an MCCH-RNTI, a G-CS-RNTI or a CS-RNTI of the communication apparatus.

In some implementations, when determining not to schedule the second PDSCH, the network apparatus may determine not to schedule the second PDSCH in both the first slot and the second slot.

In some implementations, the procedure may comprise a P-RNTI triggered system information acquisition process, and the first PDSCH may be scheduled with a SI-RNTI.

In addition, in some implementations, the second PDSCH may be scheduled with a C-RNTI, an MCS-C-RNTI or a CS-RNTI of the communication apparatus.

Regarding autonomous SI acquisition, in some implementations, during a process of autonomous SI acquisition, when Msg4 PDSCH with temporary C-RNTI (TC-RNTI) is scheduled with another PDSCH with SI-RNTI, the communication apparatus may be expected to decode the Msg4 PDSCH scheduled by TC-RNTI if the Msg4 PDSCH is not greater than 25 PRBs with 15 kHz SCS or not greater than 12 PRBs with 30 kHz SCS. Otherwise, the communication apparatus may be expected to decode the PDSCH scheduled by SI-RNTI.

### Illustrative Implementations

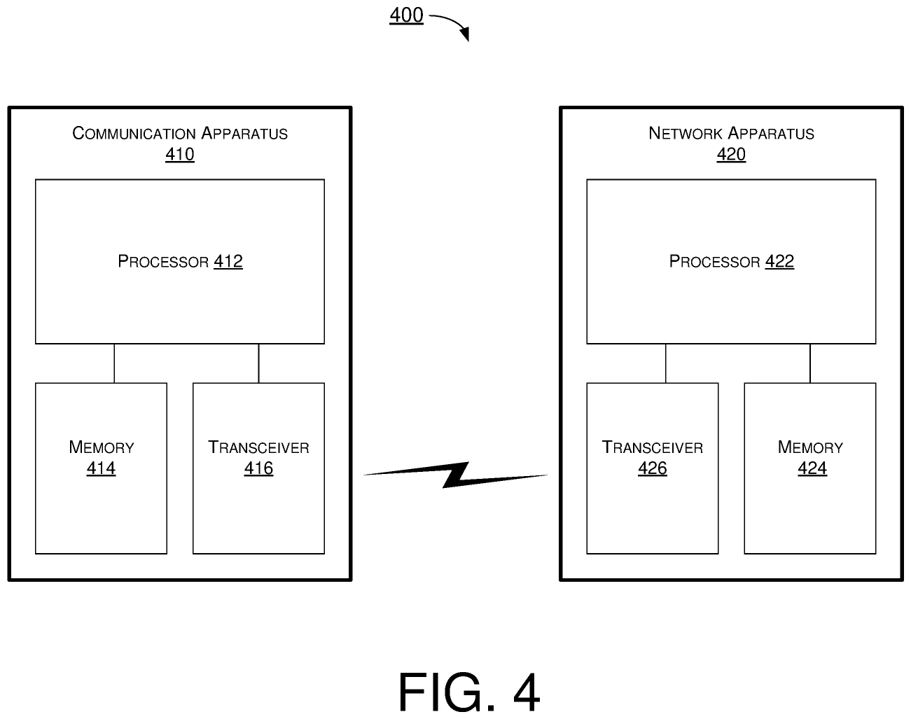

FIG. 4 illustrates an example communication system 400 having an example communication apparatus 410 and an example network apparatus 420 in accordance with an implementation of the present disclosure. Each of the communication apparatus 410 and the network apparatus 420 may perform various functions to implement schemes, techniques, processes and methods described herein pertaining to handling of simultaneous reception with respect to user equipment or handling or scheduling of simultaneous transmission with respect to network apparatus in mobile communications, including scenarios/schemes described above as well as the process 500 and the process 600 described below.

The communication apparatus 410 may be a part of an electronic apparatus, which may be a UE such as a portable or mobile apparatus, a wearable apparatus, a wireless communication apparatus or a computing apparatus. For instance, the communication apparatus 410 may be implemented in a smartphone, a smartwatch, a personal digital assistant, a digital camera, or a computing equipment such as a tablet computer, a laptop computer or a notebook computer. The communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, the communication apparatus 410 may be implemented in a smart thermostat, a smart fridge, a smart door lock, a wireless speaker or a home control center. Alternatively, the communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 410 may include at least some of those components shown in FIG. 4 such as a processor 412, for example. The communication apparatus 410 may further include one or more other components not pertinent to the proposed scheme of the present disclosure (e.g., internal power supply, display device and/or user interface device), and, thus, such component(s) of the communication apparatus 410 are neither shown in FIG. 4 nor described below in the interest of simplicity and brevity.

The network apparatus 420 may be a part of a network device, which may be a network node such as a satellite, a base station, a small cell, a router or a gateway. For instance, the network apparatus 420 may be implemented in an eNodeB in an LTE network, in a gNB in a 5G/NR, IoT, NB-IoT or IIoT network or in a satellite or base station in a 6G network. Alternatively, the network apparatus 420 may be implemented in the form of one or more IC chips such as, for example and without limitation, one or more single-core processors, one or more multi-core processors, or one or more RISC or CISC processors. The network apparatus 420 may include at least some of those components shown in FIG. 4 such as a processor 422, for example. The network apparatus 420 may further include one or more other components not pertinent to the proposed scheme of the present disclosure (e.g., internal power supply, display device and/or user interface device), and, thus, such component(s) of the network apparatus 420 are neither shown in FIG. 4 nor described below in the interest of simplicity and brevity.

In one aspect, each of the processor 412 and the processor 422 may be implemented in the form of one or more single-core processors, one or more multi-core processors, or one or more CISC processors. That is, even though a singular term “a processor” is used herein to refer to the processor 412 and the processor 422, each of the processor 412 and the processor 422 may include multiple processors in some implementations and a single processor in other implementations in accordance with the present disclosure. In another aspect, each of the processor 412 and the processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 412 and the processor 422 is a special-purpose machine specifically designed, arranged and configured to perform specific tasks including autonomous reliability enhancements in a device (e.g., as represented by the communication apparatus 410) and a network (e.g., as represented by the network apparatus 420) in accordance with various implementations of the present disclosure.

In some implementations, the communication apparatus 410 may also include a transceiver 416 coupled to the processor 412 and capable of wirelessly transmitting and receiving data. In some implementations, the communication apparatus 410 may further include a memory 414 coupled to the processor 412 and capable of being accessed by the processor 412 and storing data therein. In some implementations, the network apparatus 420 may also include a transceiver 426 coupled to the processor 422 and capable of wirelessly transmitting and receiving data. In some implementations, the network apparatus 420 may have a plurality of physical antennas which associates with a plurality of antenna ports. In some implementations, the network apparatus 420 may further include a memory 424 coupled to processor 422 and capable of being accessed by the processor 422 and storing data therein. Accordingly, the communication apparatus 410 and the network apparatus 420 may wirelessly communicate with each other via the transceiver 416 and the transceiver 426, respectively. To aid better understanding, the following description of the operations, functionalities and capabilities of each of the communication apparatus 410 and the network apparatus 420 is provided in the context of a mobile communication environment in which the communication apparatus 410 is implemented in or as a communication apparatus or a UE and the network apparatus 420 is implemented in or as a network node or a network device of a communication network.

In some implementations, the processor 412 of the communication apparatus 410 may perform a procedure to communicate with the network apparatus 420 via the transceiver 416. The procedure may involve reception of a first PDSCH scheduled in a first slot. The processor 412 may further determine to skip decoding of a second PDSCH scheduled in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

In some implementations, the procedure may comprise a random access procedure, and the first PDSCH may be scheduled with a RA-RNTI of the communication apparatus 410 or scheduled with an MSGB-RNTI of the communication apparatus 410.

In some implementations, the second PDSCH may be scheduled with a C-RNTI, an MCS-C-RNTI, a G-RNTI, an MCCH-RNTI, a G-CS-RNTI or a CS-RNTI of the communication apparatus 410.

In some implementations, in determining to skip decoding of the second PDSCH, the processor 412 may determine to skip decoding of the second PDSCH scheduled in the first slot and the second slot.

In some implementations, the procedure may comprise a P-RNTI triggered system information acquisition process, and the first PDSCH may be scheduled with an SI-RNTI.

In some implementations, the second PDSCH may be scheduled with a C-RNTI, an MCS-C-RNTI or a CS-RNTI of the communication apparatus 410.

In some implementations, the processor 422 of the network apparatus 420 may perform a procedure to communicate with the communication apparatus 410 via the transceiver 426. The procedure may involve transmission of a first PDSCH scheduled in a first slot. The processor 422 may further determine not to schedule a second PDSCH in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

In some implementations, the procedure may comprise a RA procedure triggered by the communication apparatus 410, and the first PDSCH may be scheduled with an RA-RNTI of the communication apparatus 410 or scheduled with a MSGB-RNTI of the communication apparatus 410.

In addition, in some implementations, the second PDSCH may be scheduled with a C-RNTI, an MCS-C-RNTI, a G-RNTI, an MCCH-RNTI, a G-CS-RNTI or a CS-RNTI of the communication apparatus 410.

In some implementations, when determining not to schedule the second PDSCH, the processor 422 may determine not to schedule the second PDSCH in both the first slot and the second slot.

In some implementations, the procedure may comprise a P-RNTI triggered system information acquisition process, and the first PDSCH may be scheduled with a SI-RNTI.

In addition, in some implementations, the second PDSCH may be scheduled with a C-RNTI, an MCS-C-RNTI or a CS-RNTI of the communication apparatus 410.

In some implementations, the communication apparatus 410 may be an eRedCap UE, and the bandwidth scheduled for the first PDSCH may be determined based on a number of resource block configured with a sub carrier spacing.

### Illustrative Processes

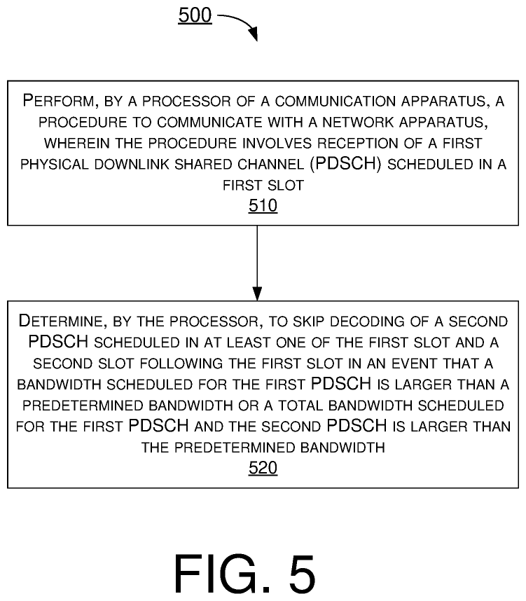

FIG. 5 illustrates an example process 500 in accordance with an implementation of the present disclosure. The process 500 may be an example implementation of above scenarios/schemes, whether partially or completely, with respect to handling of simultaneous reception of a communication apparatus with the present disclosure. The process 500 may represent an aspect of implementation of features of the communication apparatus 410. The process 500 may include one or more operations, actions, or functions as illustrated by one or more of blocks 510 and 520. Although illustrated as discrete blocks, various blocks of the process 500 may be divided into additional blocks, combined into fewer blocks, or eliminated, depending on the desired implementation. Moreover, the blocks of the process 500 may be executed in the order shown in FIG. 5 or, alternatively, in a different order. The process 500 may be implemented by the communication apparatus 410 or any suitable UE or machine type devices. Solely for illustrative purposes and without limitation, the process 500 is described below in the context of the communication apparatus 410. The process 500 may begin at block 510.

At 510, the process 500 may involve the processor 412 of the communication apparatus 410 performing a procedure to communicate with the network apparatus 420. The procedure involves reception of a first PDSCH scheduled in a first slot. The process 500 may proceed from 510 to 520.

At 520, the process 500 may involve the processor 412 determining to skip decoding of a second PDSCH scheduled in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

In some implementations, the procedure may comprise a random access procedure, and the first PDSCH may be scheduled with an RA-RNTI of the communication apparatus 410 or scheduled with a MSGB-RNTI of the communication apparatus 410.

In some implementations, the second PDSCH may be scheduled with a C-RNTI, an MCS-C-RNTI, a G-RNTI, an MCCH-RNTI, a G-CS-RNTI or a CS-RNTI of the communication apparatus 410.

In some implementations, in determining to skip decoding of the second PDSCH at block 520, the process 500 may involve the processor 412 determining to skip decoding of the second PDSCH scheduled in the first slot and the second slot.

In some implementations, the procedure may comprise a P-RNTI triggered system information acquisition process, and the first PDSCH may be scheduled with a SI-RNTI.

In some implementations, the second PDSCH may be scheduled with a C-RNTI, an MCS-C-RNTI or a CS-RNTI of the communication apparatus.

In some implementations, the communication apparatus 410 may be an eRedCap UE, and the bandwidth scheduled for the first PDSCH may be determined based on a number of resource block configured with a sub carrier spacing.

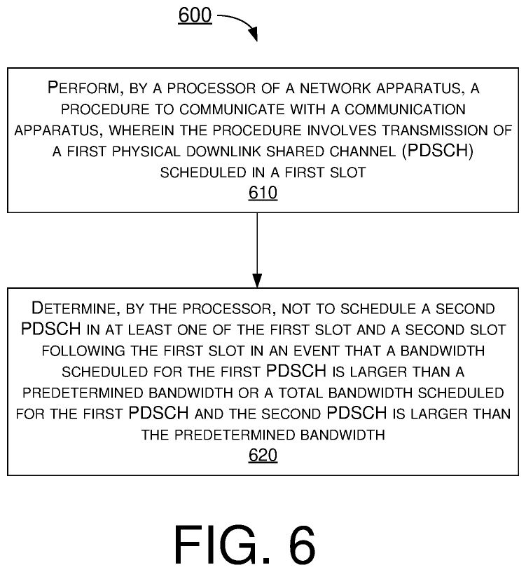

FIG. 6 depicting an example process 600 in accordance with an implementation of the present disclosure. The process 600 may be an example implementation of above scenarios/schemes, whether partially or completely, with respect to handling or scheduling of simultaneous transmission of a network apparatus with the present disclosure. The process 600 may represent an aspect of implementation of features of the network apparatus 420. The process 600 may include one or more operations, actions, or functions as illustrated by one or more of blocks 610 and 620. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the network apparatus 420 or any suitable network device or network node. Solely for illustrative purposes and without limitation, the process 600 is described below in the context of the network apparatus 420. The process 600 may begin at block 610.

At 610, the process 600 may involve the processor 422 of the network apparatus 420 performing a procedure to communicate with a communication apparatus (e.g., the communication apparatus 410), wherein the procedure involves transmission of a first PDSCH scheduled in a first slot. The process 600 may proceed from 610 to 620.

At 620, the process 600 may involve the processor 422 determining not to schedule a second PDSCH in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

In some implementations, the procedure may comprise a RA procedure triggered by the communication apparatus 410, and the first PDSCH may be scheduled with an RA-RNTI of the communication apparatus 410 or scheduled with a MSGB-RNTI of the communication apparatus 410.

In addition, in some implementations, the second PDSCH may be scheduled with a C-RNTI, an MCS-C-RNTI, a G-RNTI, an MCCH-RNTI, a G-CS-RNTI or a CS-RNTI of the communication apparatus 410.

In some implementations, in the determining of not to schedule the second PDSCH in the first slot or in the second slot at block 620, the process 600 may involve the processor 422 determining not to schedule the second PDSCH in both the first slot and the second slot.

In some implementations, the procedure may comprise a P-RNTI triggered system information acquisition process, and the first PDSCH may be scheduled with a SI-RNTI.

In addition, in some implementations, the second PDSCH may be scheduled with a C-RNTI, an MCS-C-RNTI or a CS-RNTI of the communication apparatus 410.

In some implementations, the communication apparatus 410 may be an eRedCap UE, and the bandwidth scheduled for the first PDSCH may be determined based on a number of resource block configured with a sub carrier spacing.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of a communication apparatus, a procedure to communicate with a network apparatus, wherein the procedure involves reception of a first physical downlink shared channel (PDSCH) scheduled in a first slot; and
determining, by the processor, to skip decoding of a second PDSCH scheduled in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

2. The method of claim 1, wherein the procedure comprises a random access procedure, and wherein the first PDSCH is scheduled with a random access radio network temporary identifier (RA-RNTI) of the communication apparatus or scheduled with a message B RNTI (MSGB-RNTI) of the communication apparatus.

3. The method of claim 2, wherein the second PDSCH is scheduled with a cell RNTI (C-RNTI), a modulation and coding scheme (MCS) C-RNTI (MCS-C-RNTI), a group RNTI (G-RNTI), a multicast broadcast service (MBS) control channel (MCCH) RNTI (MCCH-RNTI), a group configured scheduling RNTI (G-CS-RNTI) or a configured scheduling RNTI (CS-RNTI) of the communication apparatus.

4. The method of claim 1, wherein the determining to skip decoding of the second PDSCH further comprises:
determining, by the processor, to skip decoding of the second PDSCH scheduled in the first slot and the second slot.

5. The method of claim 1, wherein the procedure comprises a paging RNTI (P-RNTI) triggered system information acquisition process, and wherein the first PDSCH is scheduled with a system information RNTI (SI-RNTI).

6. The method of claim 5, wherein the second PDSCH is scheduled with a C-RNTI, an MCS-C-RNTI or a CS-RNTI of the communication apparatus.

7. The method of claim 1, wherein the communication apparatus is an enhanced reduced capability (eRedCap) user equipment, and wherein the bandwidth scheduled for the first PDSCH is determined based on a number of resource block configured with a sub carrier spacing.

8. A communication apparatus, comprising:
a transceiver which, during operation, wirelessly communicates with at least one network apparatus; and
a processor communicatively coupled to the transceiver such that, during operation, the processor performs operations comprising:
performing, via the transceiver, a procedure to communicate with the network apparatus, wherein the procedure involves reception of a first physical downlink shared channel (PDSCH) scheduled in a first slot; and
determining to skip decoding of a second PDSCH scheduled in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

9. The communication apparatus of claim 8, wherein the procedure comprises a random access procedure, and wherein the first PDSCH is scheduled with a random access radio network temporary identifier (RA-RNTI) of the communication apparatus or scheduled with a message B RNTI (MSGB-RNTI) of the communication apparatus.

10. The communication apparatus of claim 9, wherein the second PDSCH is scheduled with a cell RNTI (C-RNTI), a modulation and coding scheme (MCS) C-RNTI (MCS-C-RNTI), a group RNTI (G-RNTI), a multicast broadcast service (MBS) control channel (MCCH) RNTI (MCCH-RNTI), a group configured scheduling RNTI (G-CS-RNTI) or a configured scheduling RNTI (CS-RNTI) of the communication apparatus.

11. The communication apparatus of claim 8, wherein in determining to skip decoding of the second PDSCH, the processor further performs operation comprising:
determining to skip decoding of the second PDSCH scheduled in the first slot and the second slot.

12. The communication apparatus of claim 8, wherein the procedure comprises a paging RNTI (P-RNTI) triggered system information acquisition process, and wherein the first PDSCH is scheduled with a system information RNTI (SI-RNTI).

13. The communication apparatus of claim 12, wherein the second PDSCH is scheduled with a C-RNTI, an MCS-C-RNTI or a CS-RNTI of the communication apparatus.

14. A method, comprising:
performing, by a processor of a network apparatus, a procedure to communicate with a communication apparatus, wherein the procedure involves transmission of a first physical downlink shared channel (PDSCH) scheduled in a first slot; and
determining, by the processor, not to schedule a second PDSCH in at least one of the first slot and a second slot following the first slot in an event that a bandwidth scheduled for the first PDSCH is larger than a predetermined bandwidth or a total bandwidth scheduled for the first PDSCH and the second PDSCH is larger than the predetermined bandwidth.

15. The method of claim 14, wherein the procedure comprises a random access procedure triggered by the communication apparatus, and wherein the first PDSCH is scheduled with a random access radio network temporary identifier (RA-RNTI) of the communication apparatus or scheduled with a message B RNTI (MSGB-RNTI) of the communication apparatus.

16. The method of claim 15, wherein the second PDSCH is scheduled with a cell RNTI (C-RNTI), a modulation and coding scheme (MCS) C-RNTI (MCS-C-RNTI), a group RNTI (G-RNTI), a multicast broadcast service (MBS) control channel (MCCH) RNTI (MCCH-RNTI), a group configured scheduling RNTI (G-CS-RNTI) or a configured scheduling RNTI (CS-RNTI) of the communication apparatus.

17. The method of claim 14, wherein the determining of not to schedule the second PDSCH further comprises:
determining, by the processor, not to schedule the second PDSCH in the first slot and the second slot.

18. The method of claim 14, wherein the procedure comprises a paging RNTI (P-RNTI) triggered system information acquisition process, and wherein the first PDSCH is scheduled with a system information RNTI (SI-RNTI).

19. The method of claim 18, wherein the second PDSCH is scheduled with a C-RNTI, an MCS-C-RNTI or a CS-RNTI of the communication apparatus.

20. The method of claim 14, wherein the communication apparatus is an enhanced reduced capability (eRedCap) user equipment, and wherein the bandwidth scheduled for the first PDSCH is determined based on a number of resource block configured with a sub carrier spacing.
